(19) United States
(12) Patent Application Publication
(10) Pub. No.: US 2010/0309412 A1
(43) Pub. Date: Dec. 9, 2010

(54) AMBIENT LIGHT BACKLIGHT FOR TRANSMISSIVE DISPLAYS

(75) Inventor: David E. Paul, San Diego, CA (US)

Correspondence Address: Weaver Austin Villeneuve & Sampson LLP - QUAL, P.O. Box 70250, Oakland, CA, 94612-0250, US

(73) Assignee: Qualcomm MEMS Technologies, Inc.

(21) Appl. No.: 12/479,648

(22) Filed: Jun. 5, 2009

(51) Int. Cl. G02F 1/13357

(52) U.S. Cl. 349/65; 349/67

(57) ABSTRACT

Devices are provided for using ambient light to illuminate transmissive displays. One such backlight includes a light source configured to provide artificial light to the transmissive display when the backlight is closed and a surface configured to reflect ambient light to the transmissive display when the backlight is open. Another backlight includes a surface configured to provide ambient light to the transmissive display even when the backlight is closed. In some implementations, power to the light source may be reduced or shut off when the backlight is open and/or when sufficient ambient light is being provided to the transmissive display.

### FIELD OF THE INVENTION

This application relates generally to display technology and more specifically to the illumination of displays.

### BACKGROUND OF THE INVENTION

There are various devices for display illumination. Transmissive displays, such as liquid crystal displays (“LCDs”) are generally illuminated from behind with a “backlight.” The image of a transmissive display is generally formed by a spatial light modulator. A transmissive display is typically low in light transmittance and low in power efficiency. Accordingly, only a small fraction of the light from the backlight reaches the viewer. Transmissive displays generally provide their best performance in indoor environments: transmissive displays may be difficult to view outdoors, particularly in bright sunlight. It would be desirable to provide improved illumination devices and methods for transmissive displays.

### SUMMARY

Methods and devices are provided for using ambient light to illuminate transmissive displays. In some embodiments, a backlight includes a light source configured to provide artificial light to the transmissive display when the backlight is closed and a surface configured to reflect ambient light to the transmissive display when the backlight is open. Another backlight includes a surface configured to provide ambient light to the transmissive display even when the backlight is closed. In some implementations, power to the light source may be reduced or shut off when the backlight is open and/or when sufficient ambient light is being provided to the transmissive display.

In some implementations, the reflectivity of at least one surface may be changed according to whether ambient light or artificial light is being used to illuminate the transmissive display. In some such implementations, the reflectivity may be changed by controlling a microelectromechanical systems (“MEMS”) array to either reflect or transmit visible ambient light. For example, in implementations in which ambient light is provided to the transmissive display when the backlight is open, a logic system and/or control circuitry may control the MEMS array to reflect substantially more light when the backlight is open than when the backlight is closed. In such implementations, the MEMS array may be disposed in a layer that is between the backlight and the transmissive display.

For implementations in which ambient light may be provided to the transmissive display when the backlight is closed, the logic system and/or control circuitry may control the MEMS array to reflect artificial light to the transmissive display when the artificial light is illuminated. However, when the backlight is providing ambient light to the transmissive display, the logic system and/or control circuitry may control the MEMS array to transmit the ambient light to the transmissive display. In such implementations, at least one such MEMS array may be disposed in a layer that is not between the backlight and the transmissive display.

Some embodiments described herein provide an apparatus that includes a transmissive display and a backlight assembly. The transmissive display may have a first side configured for presenting images and a second side configured for receiving light. The transmissive display may, e.g., comprise an LCD. The backlight assembly may include a light source configured for providing artificial light to the second side of the transmissive display. The backlight assembly may also include a surface configured for providing ambient light to the second side of the transmissive display.

In some such embodiments, the light source may be configured to provide artificial light to the second side of the transmissive display when the backlight assembly is in a first position. The surface may be configured to transmit the artificial light from the light source when the backlight assembly is in the first position.

The surface may be configured to reflect ambient light to the second side of the transmissive display when the backlight assembly is in a second position. For example, the surface may be configured to transmit the ambient light to the second side of the transmissive display when the backlight is in closed position at which the backlight assembly is proximate the transmissive display. In some embodiments, when the backlight is in the closed position, the backlight assembly may be substantially parallel to the transmissive display. The backlight assembly may be configured to turn off the light source when the backlight assembly is in the second position.

The surface may, for example, comprise a plurality of micro-mechanical mirrors. The micro-mechanical mirrors may be configured to reflect the artificial light when the light source is powered on. Moreover, the micro-mechanical mirrors may be configured to allow the ambient light to be transmitted through the surface when the light source is not powered on. Alternatively, or additionally, the surface may comprise a reflective film.

The apparatus may include a light detector configured to detect ambient light intensity. The apparatus may include a logic system that comprises one or more logic devices (e.g., processors, programmable logic devices, etc.) The logic system may be configured to determine whether there is a sufficient ambient light intensity for the transmissive display.

Some embodiments described herein provide a mobile communication device that includes the apparatus. The mobile communication device may be, e.g., a cellular telephone, a personal digital assistant or the like.

The apparatus may also include a prompting apparatus (e.g., a speaker, a display device, etc.) for prompting a user. The logic system may be further configured to control the prompting apparatus to prompt a user when there is a sufficient ambient light intensity for the transmissive display.

Alternative embodiments described herein provide an apparatus that includes the following elements: a transmissive display having a first side configured for presenting images and a second side configured for receiving light; an interface system comprising a user interface and a network interface; a logic system configured to control the transmissive display and the interface system; and a backlight assembly. The transmissive display may, e.g., comprise an LCD.

The backlight assembly may include the following elements: a light source configured to provide artificial light to the second side of the transmissive display when the backlight is in a first position; and a surface configured to reflect ambient light to the second side of the transmissive display when the backlight is in a second position. The first position may be a closed position at which the reflective surface of the backlight assembly is proximate the transmissive display. The surface may be configured to transmit the artificial light from the light source when the backlight assembly is in the first position.

The surface may comprise a reflective film, a plurality of micro-mechanical mirrors, etc., according to the embodiment. The user interface may include a key pad and/or a touch screen. In some embodiments, the network interface may comprise a wireless interface.

Some embodiments described herein provide a mobile communication device that includes the apparatus. The mobile communication device may comprise, e.g., a cellular telephone, a personal digital assistant, etc.

The apparatus may also include a light detector configured to detect ambient light intensity. The apparatus may further comprise prompting apparatus for prompting a user. The logic system may be configured to control the prompting apparatus to prompt a user when there is a sufficient ambient light intensity for the transmissive display. The prompting apparatus may comprise a speaker and/or a display.

Alternative embodiments provide an apparatus with the following elements: a transmissive display configured for presenting images; an interface for receiving user input and for communicating with a network; control apparatus for controlling the transmissive display and the interface; and an illumination apparatus for proving illumination to the transmissive display. The illumination apparatus may include these elements: a light source for providing artificial light to the transmissive display when the illumination apparatus is in a first position; and apparatus for reflecting ambient light to the transmissive display when the illumination apparatus is in a second position. A mobile communication device (e.g., such as described herein) may include the apparatus.

These and other methods of the invention may be implemented by various types of hardware, software, firmware, etc. For example, some features of the invention may be implemented, at least in part, by computer programs embodied in machine-readable media. The computer programs may, for example, include instructions for controlling a device to make a response when the intensity of ambient light is sufficient for illumination of a transmissive display. The response may depend on the manner in which ambient light is used for illumination of the display. If ambient light is used when the display is in an open position, the response may comprise a prompt to a user of the device, e.g., an audio or visual prompt to turn off a light source of the backlight assembly and/or to open the backlight assembly. If ambient light is used when the display is in a closed position, the response may comprise switching off the backlight or prompting the user to switch off the backlight. The response may also involve controlling the reflectivity of a surface, e.g., by controlling the state of a MEMS array either to reflect or to transmit substantially more visible ambient light.

### BRIEF DESCRIPTION OF THE DRAWINGS

FIG. 1 depicts a simplified version of a display device that may include a backlight as provided herein.

FIG. 2 is a block diagram that illustrates some examples of components of the display device of FIG. 1.

FIG. 3A illustrates one example of a backlight for transmissive displays in a closed position.

FIG. 3B illustrates one example of a backlight for transmissive displays in an open position.

FIG. 4A illustrates a cross-sectional view of a device such as that depicted in FIG. 3B.

FIG. 4B provides an alternative example of a device for providing ambient light to a transmissive display.

FIG. 4C is a flow chart that outlines steps of a method for providing ambient light to a transmissive display.

FIG. 4D is a flow chart that outlines steps of an alternative method for providing ambient light to a transmissive display.

FIG. 5 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 6A is a cross section of the device of FIG. 5.

FIG. 6B is a cross section of an alternative embodiment of an interferometric modulator.

FIG. 6C is a cross section of another alternative embodiment of an interferometric modulator.

FIG. 6D is a cross section of yet another alternative embodiment of an interferometric modulator.

FIG. 6E is a cross section of an additional alternative embodiment of an interferometric modulator.

FIG. 7A is a schematic cross-section of a modulator device capable of switching between a highly transmissive state and a highly reflective state.

FIG. 7B is a plot of the index of refraction of an ideal theoretical material used in the modulator device of FIG. 7A as a function of wavelength.

FIG. 7C is a plot of the reflection of the modulator device of FIG. 8A as a function of wavelength and air gap height.

FIG. 7D is a plot of the transmission of the modulator device of FIG. 8A as a function of wavelength and air gap height.

FIG. 8A is a schematic cross-section of another embodiment of a modulator device capable of switching between a highly transmissive state and a highly reflective state.

FIG. 8B is a plot of the reflection of the modulator device of FIG. 8A as a function of wavelength and air gap height.

FIG. 8C is a plot of the transmission of the modulator device of FIG. 8A as a function of wavelength and air gap height.

### DETAILED DESCRIPTION

While the present invention will be described with reference to a few specific embodiments, the description and specific embodiments are merely illustrative of the invention and are not to be construed as limiting the invention. Various modifications can be made to the described embodiments without departing from the true spirit and scope of the invention as defined by the appended claims. For example, the steps of methods shown and described herein are not necessarily performed in the order indicated. It should also be understood that the methods of the invention may include more or fewer steps than are indicated. In some implementations, steps described herein as separate steps may be combined. Conversely, what may be described herein as a single step may be implemented in multiple steps.

Similarly, device functionality may be apportioned by grouping or dividing tasks in any convenient fashion. For example, when steps are described herein as being performed by a single device (e.g., by a single logic device), the steps may alternatively be performed by multiple devices and vice versa.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Methods and devices are provided for using ambient light to illuminate transmissive displays. In some embodiments, a backlight includes a light source configured to provide artificial light to the transmissive display when the backlight is closed and a surface configured to reflect ambient light to the transmissive display when the backlight is open. Another backlight includes a surface configured to provide ambient light to the transmissive display even when the backlight is closed. In some implementations, power to the light source may be reduced or shut off when the backlight is open and/or when sufficient ambient light is being provided to the transmissive display.

Some implementations may include apparatus for controlling a device to make a response according to changed conditions, e.g., when the backlight is open and/or when the intensity of ambient light is sufficient for illumination of a transmissive display. The response may depend on the manner in which ambient light is used for illumination of the display. If ambient light is used when the display is in an open position, the response may comprise a prompt to a user of the device, e.g., an audio or visual prompt, to open the backlight portion. If ambient light is used when the display is in a closed position, the response may comprise switching off the backlight.

The response may involve controlling the reflectivity of a surface. In some implementations, the reflectivity of at least one surface may be changed according to whether ambient light or artificial light is being used to illuminate the transmissive display. In some such implementations, the reflectivity may be changed by controlling a MEMS array to either reflect or transmit substantially more visible ambient light. Some such implementations are described in detail below.

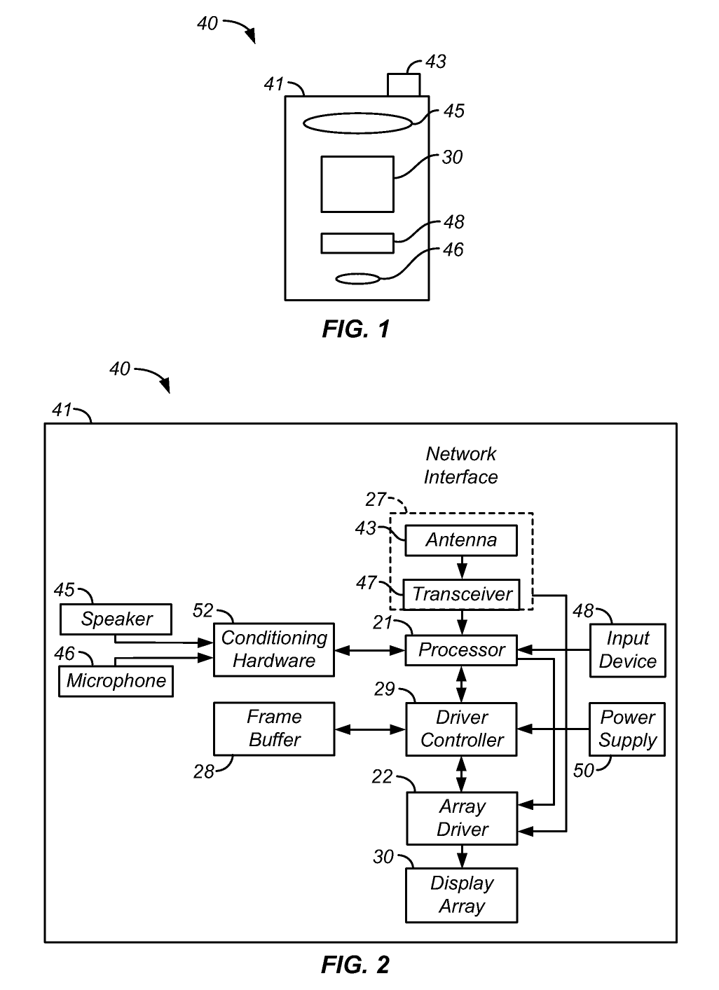

FIGS. 1 and 2 are system block diagrams illustrating an embodiment of a display device 40. The display device 40 can be, for example, a portable device such as a cellular or mobile telephone, a personal digital assistant (“PDA”), etc. However, the same components of display device 40 or slight variations thereof are also illustrative of various types of display devices such as televisions and portable media players.

This example of display device 40 includes a housing 41, a display 30, an antenna 43, a speaker 45, an input system 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 in this example of the display device 40 may be any of a variety of displays. Moreover, although only one display 30 is illustrated in FIG. 1, display device 40 may include more than one display 30. For example, the display 30 may comprise a flat-panel display, such as plasma, an electroluminescent (EL) display, a light-emitting diode (LED) (e.g., organic light-emitting diode (OLED)), a transmissive display such as a liquid crystal display (LCD), a bi-stable display, etc. Alternatively, display 30 may comprise a non-flat-panel display, such as a cathode ray tube (CRT) or other tube device, as is well known to those of skill in the art. However, for the embodiments of primary interest in this application, the display 30 includes at least one transmissive display.

The components of one embodiment in this example of display device 40 are schematically illustrated in FIG. 2. The illustrated display device 40 includes a housing 41 and can include additional components at least partially enclosed therein. For example, in one embodiment, the display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input system 48 and a driver controller 29. The driver controller 29 is coupled to a frame buffer 28 and to an array driver 22, which in turn is coupled to a display array 30. A power supply 50 provides power to all components as required by the particular display device 40 design.

The network interface 27 includes the antenna 43 and the transceiver 47 so that the display device 40 can communicate with one or more devices over a network. In some embodiments, the network interface 27 may also have some processing capabilities to relieve requirements of the processor 21. The antenna 43 may be any antenna known to those of skill in the art for transmitting and receiving signals. In one embodiment, the antenna is configured to transmit and receive RF signals according to an Institute of Electrical and Electronics Engineers (IEEE) 802.11 standard, e.g., IEEE 802.11(a), (b), or (g). In another embodiment, the antenna is configured to transmit and receive RF signals according to the BLUETOOTH standard. In the case of a cellular telephone, the antenna may be designed to receive Code Division Multiple Access (“CDMA”), Global System for Mobile communications (“GSM”), Advanced Mobile Phone System (“AMPS”) or other known signals that are used to communicate within a wireless cell phone network. The transceiver 47 may pre-process the signals received from the antenna 43 so that the signals may be received by, and further manipulated by, the processor 21. The transceiver 47 may also process signals received from the processor 21 so that the signals may be transmitted from the display device 40 via the antenna 43.

In an alternative embodiment, the transceiver 47 may be replaced by a receiver and/or a transmitter. In yet another alternative embodiment, network interface 27 may be replaced by an image source, which may store and/or generate image data to be sent to the processor 21. For example, the image source may be a digital video disk (DVD) or a hard disk drive that contains image data, or a software module that generates image data. Such an image source, transceiver 47, a transmitter and/or a receiver may be referred to as an “image source module” or the like.

Processor 21 may be configured to control the overall operation of the display device 40. The processor 21 may receive data, such as compressed image data from the network interface 27 or an image source, and process the data into raw image data or into a format that is readily processed into raw image data. The processor 21 may then send the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 may include a microcontroller, central processing unit (“CPU”), or logic unit to control operation of the display device 40. Conditioning hardware 52 generally includes amplifiers and filters for transmitting signals to the speaker 45, and for receiving signals from the microphone 46. Conditioning hardware 52 may be discrete components within the display device 40, or may be incorporated within the processor 21 or other components. Processor 21, driver controller 29, conditioning hardware 52 and other components that may be involved with data processing may sometimes be referred to herein as parts of a “logic system” or the like.

The driver controller 29 may be configured to take the raw image data generated by the processor 21 directly from the processor 21 and/or from the frame buffer 28 and reformat the raw image data appropriately for high speed transmission to the array driver 22. Specifically, the driver controller 29 may be configured to reformat the raw image data into a data flow having a raster-like format, such that it has a time order suitable for scanning across the display array 30. Then the driver controller 29 may send the formatted information to the array driver 22. Although a driver controller 29, such as a LCD controller, is often associated with the system processor 21 as a stand-alone integrated circuit (“IC”), such controllers may be implemented in many ways. For example, they may be embedded in the processor 21 as hardware, embedded in the processor 21 as software, or fully integrated in hardware with the array driver 22. An array driver 22 that is implemented in some type of circuit may be referred to herein as a “driver circuit” or the like.

The array driver 22 may be configured to receive the formatted information from the driver controller 29 and reformat the video data into a parallel set of waveforms that are applied many times per second to the plurality of leads coming from the display's x-y matrix of pixels. These leads may number in the hundreds, the thousands or more, according to the embodiment.

In some embodiments, the driver controller 29, array driver 22, and display array 30 may be appropriate for any of the types of displays described herein. For example, in one embodiment, driver controller 29 may be a transmissive display controller, such as an LCD display controller. Alternatively, driver controller 29 may be a bi-stable display controller (e.g., an interferometric modulator controller). In another embodiment, array driver 22 may be a transmissive display driver or a bi-stable display driver (e.g., an interferometric modulator display driver). In some embodiments, a driver controller 29 may be integrated with the array driver 22. Such embodiments may be appropriate for highly integrated systems such as cellular phones, watches, and other devices having small area displays. In yet another embodiment, display array 30 may comprise a display array such as a bi-stable display array (e.g., a display including an array of interferometric modulators).

The input system 48 allows a user to control the operation of the display device 40. In some embodiments, input system 48 includes a keypad, such as a QWERTY keyboard or a telephone keypad, a button, a switch, a touch-sensitive screen, or a pressure- or heat-sensitive membrane. In one embodiment, the microphone 46 may comprise at least part of an input system for the display device 40. When the microphone 46 is used to input data to the device, voice commands may be provided by a user for controlling operations of the display device 40.

Power supply 50 can include a variety of energy storage devices. For example, in some embodiments, power supply 50 may comprise a rechargeable battery, such as a nickel-cadmium battery or a lithium ion battery. In another embodiment, power supply 50 may comprise a renewable energy source, a capacitor, or a solar cell such as a plastic solar cell or solar-cell paint. In some embodiments, power supply 50 may be configured to receive power from a wall outlet.

In some embodiments, control programmability resides, as described above, in a driver controller which can be located in several places in the electronic display system. In some embodiments, control programmability resides in the array driver 22.

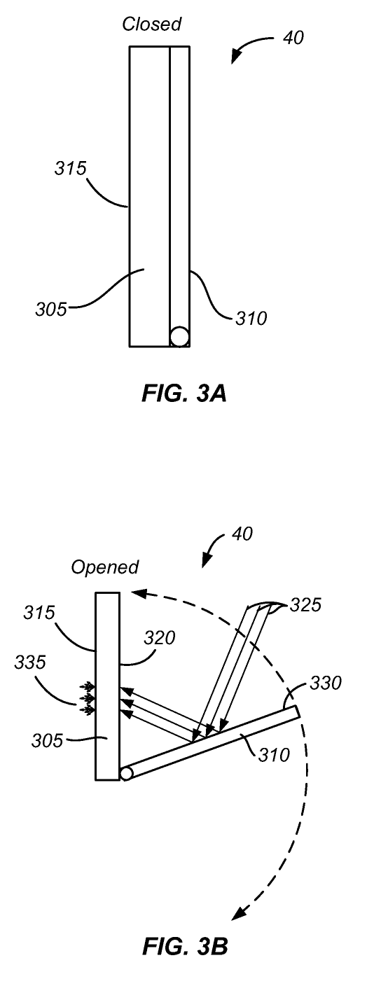

Referring now to FIGS. 3A and 3B, some embodiments of display device 40 will be discussed that can provide artificial light or ambient light to a transmissive display. In FIG. 3A, backlight assembly 310 is shown in a closed position adjacent to transmissive display 305. In FIG. 3B, backlight assembly 310 is shown in an open position. Transmissive display 305 may be any suitable type of transmissive display, such as a type of LCD.

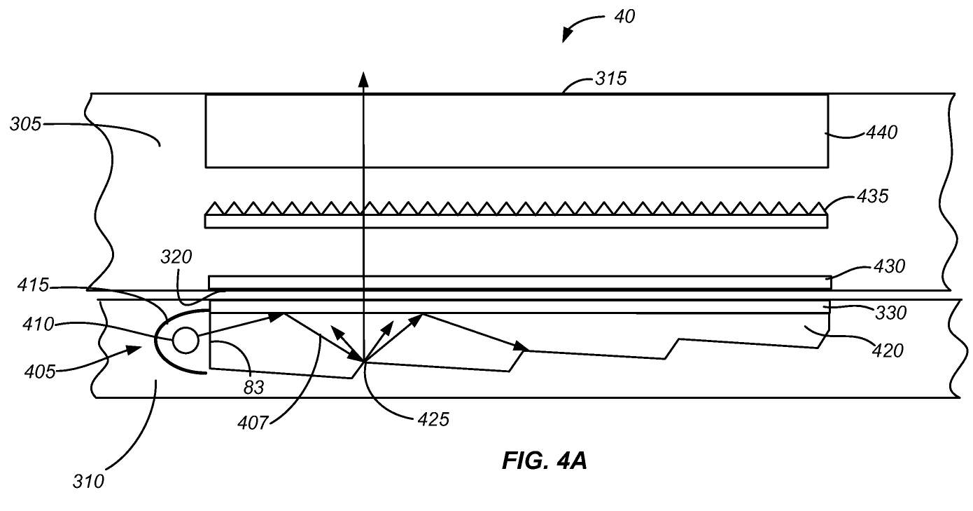

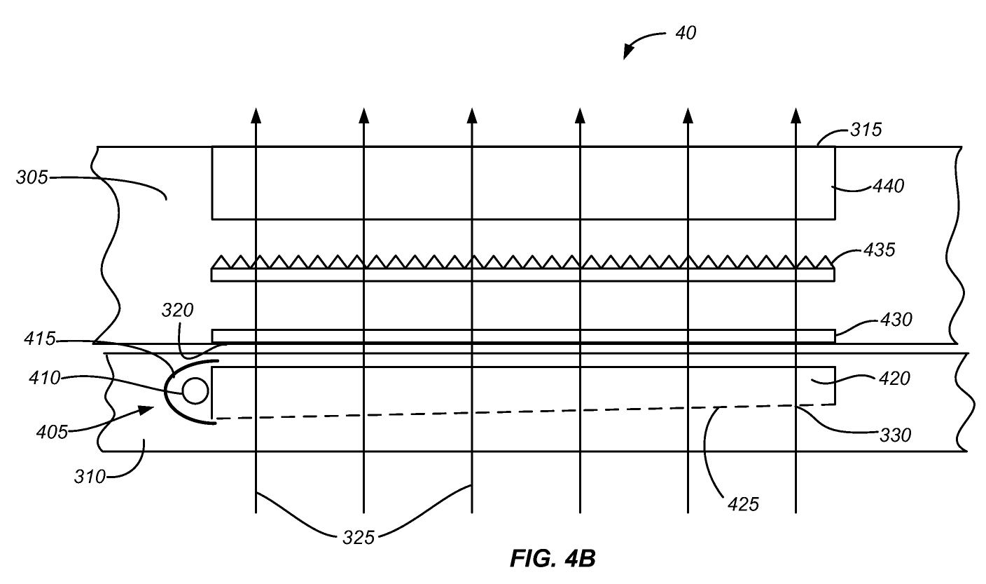

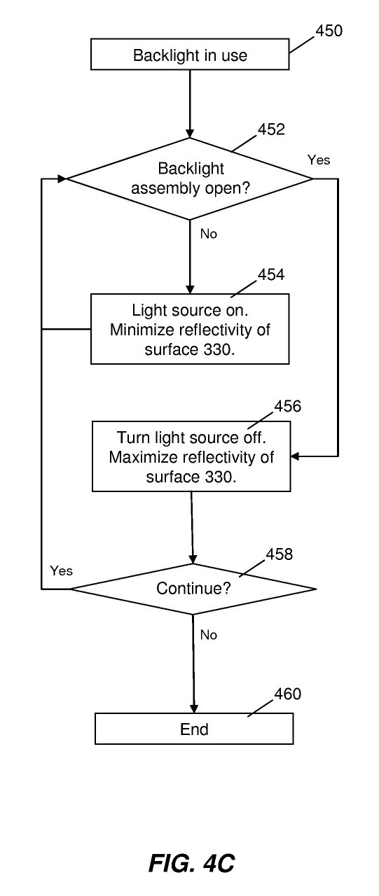

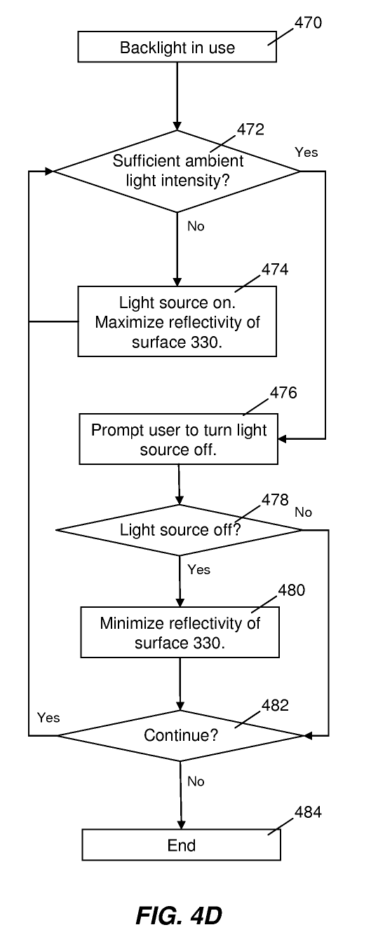

When in the closed position depicted in FIG. 3A, transmissive display 305 is configured to receive at least artificial light from backlight assembly 310. A light source and other details of some embodiments of backlight assembly 310 are described below with reference to FIGS. 4A and 4B. Using this light, transmissive display 305 is configured to present images on side 315. Side 320 of transmissive display 305 is configured to receive artificial and/or ambient light from backlight assembly 310. As used herein, “ambient light” refers to any type of light, whether natural (e.g., sunlight) or artificial, other than that provided by an artificial light source of display device 40, e.g., by a light source of backlight assembly 310.

FIG. 3B depicts an embodiment in which backlight assembly 310 provides ambient light to transmissive display 305 via reflective surface 330. Here, at least some of the available ambient light 325 reflects from reflective surface 330 to a surface 320 of transmissive display 305 that is configured to receive light. In this example, ambient light 325 has an intensity that is sufficient to traverse and illuminate transmissive display 305, thereby presenting images on side 315 via emerging light 335.

Various types of reflective surfaces 330 are contemplated herein. In some embodiments, reflective surface 330 may comprise a reflective film such as a “one way mirror” that reflects some percentage of incident light and transmits some other percentage. Such mirrors are sometimes referred to as “half silvered mirrors” because they may be formed by applying a thinner layer of reflective material (e.g., a metal such as silver) than would otherwise be applied to form a more completely reflective mirror. For example, reflective surface 330 may comprise a layer of substantially transparent material (e.g., glass, polycarbonate, plastic, etc.) coated with a layer of metal only a few dozen atoms thick.

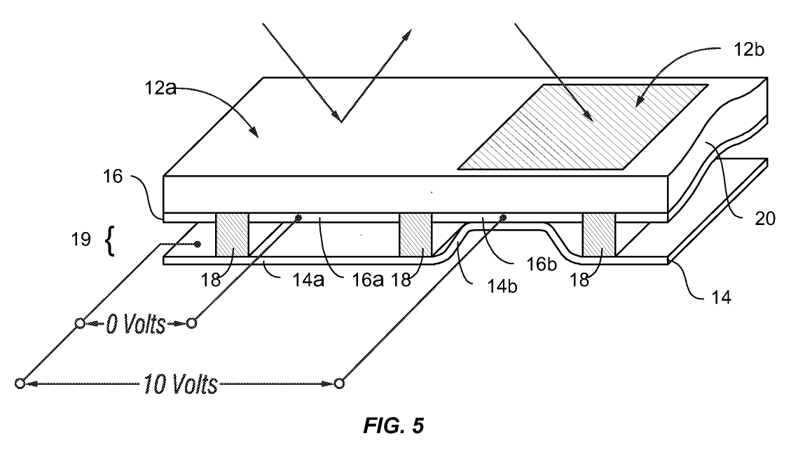

In other embodiments, reflective surface 330 may comprise a MEMS array such as a plurality of micro-mechanical mirrors, e.g., as described below with reference to FIGS. 5 et seq. In some such implementations, the reflectivity of reflective surface 330 may be changed according to whether ambient light or artificial light from backlight assembly 310 is being used to illuminate the transmissive display. For example, the reflectivity may be changed by controlling a MEMS array either to reflect or transmit most visible ambient light.

For implementations in which ambient light is provided to the transmissive display when the backlight is open (e.g., the embodiment depicted in FIG. 3B), a logic system and/or control circuitry (e.g., processor 21 of display device 40, illustrated in FIG. 2) may control the MEMS array to reflect substantially more light when the backlight is open than when the backlight is closed. In some such implementations, reflective surface 330 may be disposed between transmissive display 305 and at least some components of backlight assembly 310. As described below with reference to FIGS. 4A and 4B, however, other components that may normally be associated with a backlight assembly may be disposed between light-receiving surface 320 and image-producing surface 315 of transmissive display 305.

For implementations in which ambient light may be provided to the transmissive display when the backlight is closed, the logic system and/or control circuitry may control the MEMS array to reflect artificial light to the transmissive display when the artificial light is illuminated. However, when the backlight is providing ambient light to the transmissive display, the logic system and/or control circuitry may control the MEMS array to allow artificial light to be transmitted through surface 330 to the transmissive display. In such implementations, at least one MEMS array may be disposed in a layer that is not between the backlight and the transmissive display.

FIG. 4A provides a cross-sectional view of one embodiment of display device 40. The embodiment depicted in FIG. 4A is configured to provide ambient light to transmissive display 305, via reflective surface 330, when backlight assembly 310 is in an open position. Because backlight assembly 310 is in a closed position in FIG. 4A, reflective surface 330 is positioned next to light receiving side 320 of transmissive display 305

In this example, backlight assembly 310 includes a light source 405 and a waveguide 420. Waveguide 420 may be a light guide that comprises, e.g., one or more film, film stack, sheet, and/or slab-like components. Here, light source 405 includes a light emitting diode (“LED”) 410 and reflector 415. However, other embodiments may comprise a different type of light source, e.g., a cold cathode fluorescent lamp (“CCFL”) or a hot cathode fluorescent lamp (“HCFL”).

Here, waveguide 420 includes light extracting features 425 that direct at least some of the light propagating in the light guide to transmissive display 305. Although light extracting features 425 are depicted as prismatic features in FIG. 4A, in other embodiments light extracting features 425 may comprise holographic elements, light-scattering dots, etc. Moreover, although light extracting features 425 are depicted in FIGS. 4A and 4B as being on the distal side of waveguide 420, relative to transmissive display 305, in alternative embodiments light extracting features 425 may be formed on the proximal side of waveguide 420, relative to transmissive display 305.

Accordingly, for implementations wherein light extracting features 425 comprise holographic elements, the holographic elements may be reflective, transmissive or volume holographic elements. Light extracting features 425 that comprise reflective holographic elements would generally be formed on the distal side of waveguide 420, whereas light extracting features 425 that comprise transmissive holographic elements would generally be formed on the proximal side of waveguide 420. In some such implementations, holographic light extracting features 425 may be laminated to the distal or the proximal side of waveguide 420. In alternative implementations wherein holographic light extracting features 425 comprise volume holographic elements, holographic light extracting features 425 may be formed within waveguide 420.

In this example, light source 405 is optically coupled to an edge of the waveguide 420 (“edge-coupled”). A portion of light 407 emitted by the light source 405 enters the edge 83 of the waveguide 420 and propagates through the waveguide 420 according to the phenomenon of total internal reflection. As described above, the waveguide 420 can include light extracting features 425 that re-direct a portion of the light 407 propagating through the film towards the transmissive display 305. In this example, waveguide 420 is thick enough to provide a sufficiently large edge to receive and couple light from the light source 405. However, other implementations of backlight assembly 310 may have different configurations, e.g., they may involve side coupling, back lighting, an electroluminescent panel (“ELP”), etc.

In the embodiments depicted in FIGS. 4A and 4B, transmissive display 305 includes some components that might otherwise be part of a backlight assembly. For example, transmissive display 305 includes diffuser 430, which diffuses the light received by side 320. Diffuser 430 may comprise, e.g., one or more layers of a substantially transparent material (such as plastic, glass, etc.) that diffuses the light via a series of bumps or other diffusing features. A conventional backlight assembly might include a component similar to diffuser 430. However, for embodiments of display device 40 wherein ambient light may be provided when backlight assembly 310 is in an open position (e.g., the embodiments depicted in FIGS. 3B and 4A), separating diffuser 430 from backlight assembly 310 allows even lighting to be provided to the other elements of transmissive display 305 even when non-diffuse ambient light (e.g., sunlight) is received by side 320.

Collimating film 435 collimates the light that is received from side 320 after the light passes through diffuser 430. Like diffuser 430, a component such as collimating film 435 might be used in a conventional backlight assembly. However, ambient light may enter side 320 at a wide range of angles when backlight assembly 310 is open. If collimating film 435 were part of the backlight assemblies 310 depicted in FIGS. 3B and 4A, the ambient light entering LCD 440 would not be collimated. Separating collimating film 435 from backlight assembly 310 allows the ambient light entering LCD 440 to be collimated.

Backlight assembly 310 and/or transmissive display 305 may include other features not depicted in FIG. 4A or FIG. 4B, such as polarizing layers, a thin-film transistor (TFT”), a color filter, passivation layers, etc. However, these details are not shown or described herein in order to avoid obscuring more important features.

FIG. 4B illustrates an embodiment of display device 40 wherein transmissive display 305 may be illuminated by ambient light even when backlight assembly 310 is in a closed position. Such embodiments of display device 40 may be quite similar to the embodiment depicted in FIG. 4A. One distinction, however, is that in embodiments such as that shown in FIG. 4B, at least one reflective surface 330 may not be disposed in the optical path between waveguide 420 and transmissive display 305 when backlight assembly 310 is in a closed position.

Other such embodiments of display device 40 may be configured differently: for example, some embodiments may not be configurable to open backlight assembly 310. Still other embodiments may be configurable to open backlight assembly 310, but may also have an additional reflective surface 330 that is disposed in the optical path between waveguide 420 and transmissive display 305 when backlight assembly 310 is in a closed position. In some such implementations, the reflectivity of second reflective surface 330 may be configurable, e.g., as described elsewhere with reference to FIG. 4A and/or FIG. 3B.

However, in the example shown in FIG. 4B, reflective surface 330 is part of waveguide 420. When transmissive display 305 is being illuminated by light source 405, reflective surface 330 is configured to reflect more incident light than when transmissive display 305 is being illuminated by ambient light 325. This configuration allows waveguide 420 to function normally when reflective surface 330 is configured to be in its relatively more reflective state: light from light source 405 can be internally reflected within waveguide 420 and can be extracted by light extracting features 425, which are light-scattering dots in this example. However, when there is sufficient ambient light to illuminate transmissive display 305, reflective surface 330 may be configured to a relatively more transmissive state, to facilitate the transmission of light through display device 40.

For embodiments such as those illustrated in FIGS. 3B and 4A, wherein transmissive display 305 may be illuminated by ambient light when backlight assembly 310 is in an open position, there can still be advantages to modulating the reflectivity of reflective surface 330. In such embodiments, it can be advantageous to make reflective surface 330 relatively more reflective when backlight assembly 310 is in an open position, so that more ambient light can be directed to transmissive display 305. When backlight assembly 310 is in a closed position, reflective surface 330 may be configured to be relatively more transmissive, so that more of the light 407 that is extracted from waveguide 420 can reach transmissive display 305.

As noted above, in some alternative configurations of the general embodiment shown in FIG. 4B, a second reflective surface 330 may be positioned as shown in FIG. 4A. This second reflective surface 330 may be configured to be relatively more transmissive when backlight assembly 310 is in a closed position and configured to be relatively more reflective when backlight assembly 310 is in an open position.

FIG. 4C is a flow chart that outlines the steps of a method that may be relevant, e.g., to an embodiment wherein ambient light can be provided to a transmissive display when a backlight assembly is open. In step 450, a backlight is providing light to the transmissive display. In step 452, it is determined whether backlight assembly 310 is open. This determination may be made by a switch, by a sensor, by a logic device of a logic system (e.g., by processor 21 illustrated in FIG. 2), or by any other appropriate means. If it is determined in step 452 that backlight assembly 310 is open, light source 405 of backlight assembly 310 is switched off and the reflectivity of surface 330 is maximized. If it is determined in step 452 that backlight assembly 310 is not open, light source 405 of backlight assembly 310 is left on and the reflectivity of surface 330 is maintained in a minimally reflective state, to maximize the amount of light provided to transmissive display 305 from light source 405. In step 458, it is determined whether to continue or to end the process. For example, the process may end when a user powers off the display device 40.

FIG. 4D is a flow chart that outlines the steps of a method that may be relevant, e.g., to an embodiment wherein ambient light can be provided to a transmissive display even when a backlight assembly is closed. In step 470, a backlight is providing light to the transmissive display. In step 472, it is determined whether there is sufficient ambient light available to illuminate transmissive display 305 adequately. This determination may be made, e.g., by a light sensor (also referred to herein as a “light detector”) of display device 40. The light sensor may, e.g., be configured for communication with a logic device of a logic system (e.g., by processor 21 illustrated in FIG. 2).

If it is determined in step 452 that there is sufficient ambient light available to illuminate transmissive display 305 adequately, an audio and/or visual prompt may be provided to a device user. For example, a message may appear on display 30, a message may be provided via one or more speakers, etc. (In alternate implementations, light source 405 may be powered off automatically if it is determined in step 452 that there is sufficient ambient light available to illuminate transmissive display 305 adequately.) If it is determined in step 478 that the user has switched off light source 405, the reflectivity of surface 330 is minimized (step 480) to allow ambient light to reach transmissive display 305. If it is determined step 478 that the user has not switched off light source 405, the reflectivity of surface 330 is maintained in a reflective state, to maximize the amount of light provided to transmissive display 305 from light source 405.

In step 482, it is determined whether to continue or to end the process. For example, the process may end when a user powers off the display device 40. In some implementations, if it is determined in step 478 that the user has not yet switched off light source 405, the process will continue. For example, the process may return to step 472 after a time delay.

As noted above, some embodiments of reflective surface 330 may comprise a MEMS array (also referred to herein as a “MEMS system” or the like). Such a MEMS system may include a substantially transparent substrate and a plurality of MEMS devices disposed on or adjacent the transparent substrate. The MEMS devices may include a layer movable between a first position, wherein the surface is substantially transmissive to incident light, and a second position in which the reflection of incident light is substantially increased. Some such implementations may include a light sensor configured to detect ambient light intensity in a location proximate the substrate and logic system and/or control circuitry in electrical communication with the light detector. The logic system and/or control circuitry may control the state of the MEMS device based, at least in part, upon ambient light intensity information from the light sensor.

One interferometric modulator display embodiment comprising an interferometric MEMS display element is illustrated in FIG. 5. In these devices, the pixels are in either a bright or dark state. In the bright (“on” or “open”) state, the display element reflects a large portion of incident visible light. When in the dark (“off” or “closed”) state, the display element transmits a substantial amount of, and reflects relatively little of, the incident visible light. Depending on the embodiment, the light reflectance properties of the “on” and “off” states may be reversed. If so desired, MEMS pixels can be configured to reflect predominantly at selected wavelength ranges.

FIG. 5 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap (“air gap” or simply “gap”) with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 5 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent, and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the gap 19 remains between the movable reflective layer 14a and optical stack 16a, with the movable reflective layer 14a in a mechanically relaxed state, as illustrated by the pixel 12a in FIG. 5. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 5. The behavior is the same regardless of the polarity of the applied potential difference. In this way, row/column actuation that can control the reflective vs. non-reflective pixel states is analogous in many ways to that used in conventional LCD and other display technologies.

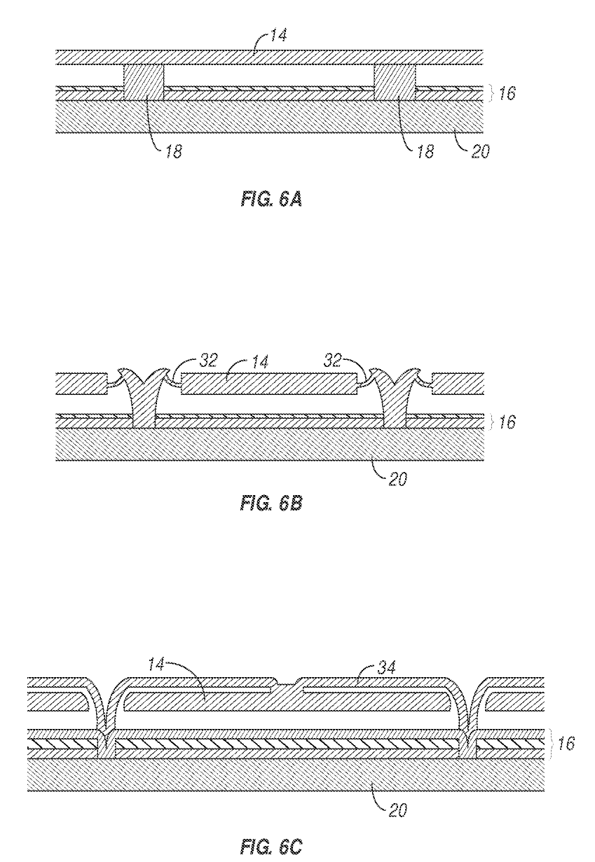

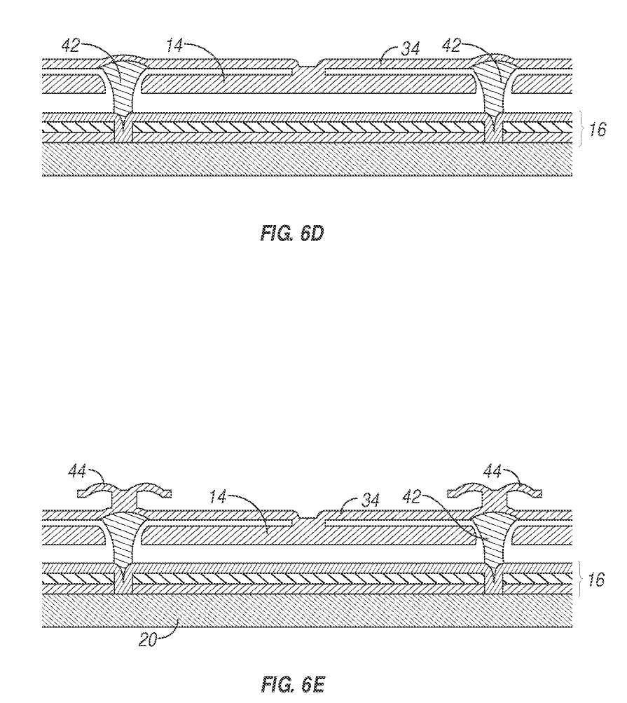

The details of the structure of interferometric modulators that operate in accordance with the principles set forth above may vary widely. For example, FIGS. 6A-6E illustrate five different embodiments of the movable reflective layer 14 and its supporting structures. FIG. 6A is a cross section of the embodiment of FIG. 1, where a strip of metal material 14 is deposited on orthogonally extending supports 18. In FIG. 6B, the moveable reflective layer 14 is attached to supports at the corners only, on tethers 32. In FIG. 6C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts.

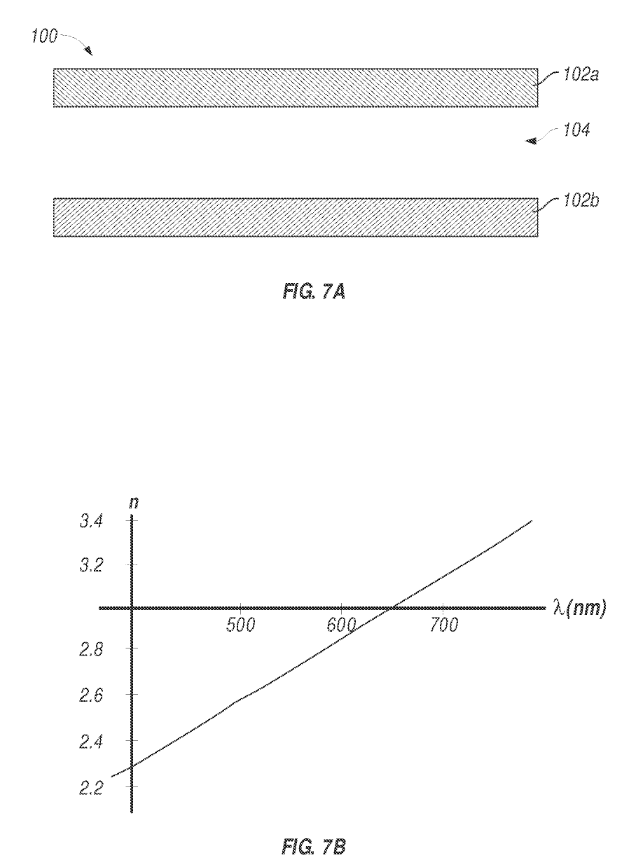

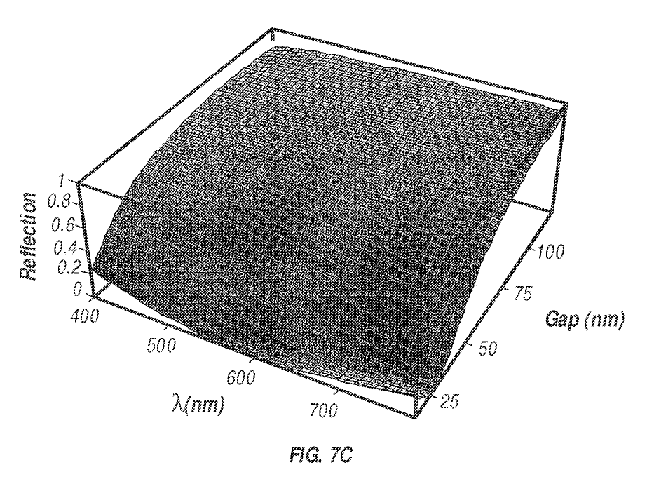

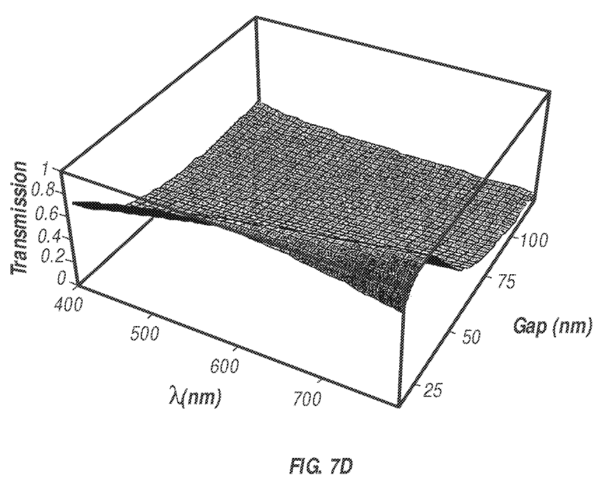

The embodiment illustrated in FIG. 6D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42.

The embodiment illustrated in FIG. 6E is based on the embodiment shown in FIG. 6D, but may also be adapted to work with any of the embodiments illustrated in FIGS. 7A-7C, as well as additional embodiments not shown. In the embodiment shown in FIG. 6E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 6, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 6E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 6C-6E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

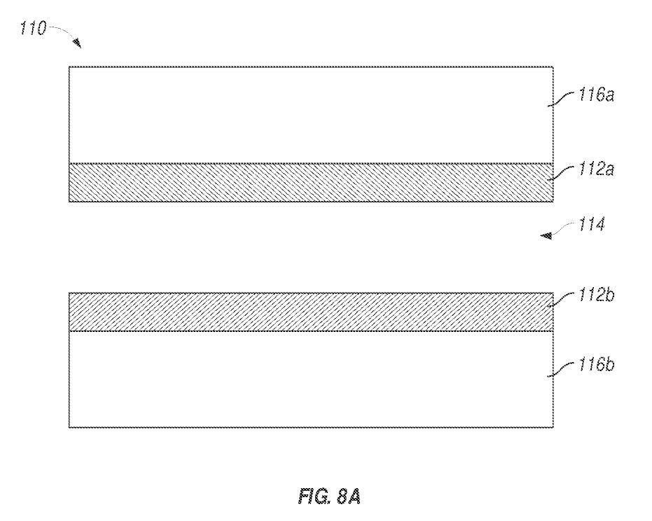

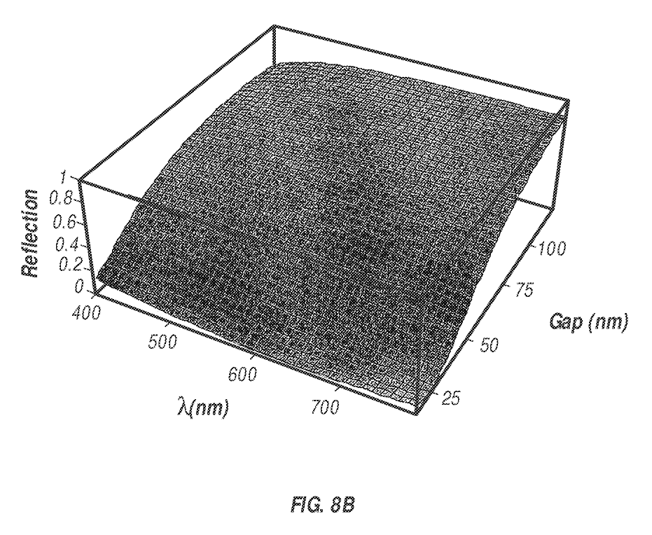

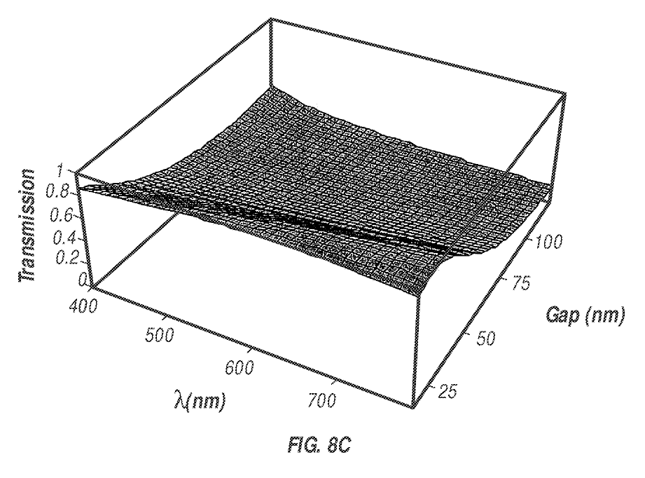

The refractive index of a material may vary as a function of wavelength. Thus, for light incident at an angle upon an interferometric modulator, the effective optical path may vary for different wavelengths of light, depending on the materials used in the optical stack and the movable layer. FIG. 7A illustrates a simplified modulator device 100 having two layers 102a and 102b movable relative to one another and separated by an air gap 104. Note that in FIG. 7A and FIGS. 8A, 9A, 10A, 11A, and 12A, features such as posts 18 (shown in FIG. 6A) that separate the layers 102a and 102b are not shown for the sake of clarity. FIG. 7B illustrates the refractive index versus wavelength λ (in nm) of an ideal theoretical material having a refractive index which varies linearly based on wavelength. Such a material can be used to create a simulated modulator device which is highly transmissive for a first air gap height and highly reflective for a second air gap height, due to the variance in the index of refraction as a function of wavelength seen in FIG. 7B.

For a simulated device in which the layers 100a and 100b are formed from the theoretical material of FIG. 7B, and have thicknesses of roughly 43 nm, their predicted reflection as a function of wavelength λ (in nm) and the size of the air gap (in nm) 104 is shown in FIG. 7C. Similarly, the transmission as a function of wavelength λ (in nm) and air gap 104 size (in nm) can be seen in FIG. 7D. Such a simulated device using the theoretical material could thus move from being highly transmissive to highly reflective across a broad wavelength range.

The predicted plots of transmission and reflection in FIGS. 7C and 7D, as well as the ones shown elsewhere in the application, are based upon optical models of the described system, taking into account the specific materials and thicknesses, as well as the optical properties of those materials, such as the index of refraction.

In another simulated device, FIG. 8A illustrates a simplified modulator device 110 which comprises layers 112a and 112b of the theoretical material of FIG. 7B, supported on two comparatively thick glass substrates 116a and 116b, and spaced apart from one another by the air gap 114. If a layer such as the glass substrate 116a or 116b is thick enough relative to the wavelength of the light in question, it no longer functions as a thin film layer and will have little effect on the optical properties of the simulated modulator device 110. For example, if the layer is thicker than the coherent length of the incident light, e.g., greater than 10 microns, the layer will no longer act as a thin film and will have little optical effect beyond the reflectivity of the layer. If the layer is comparatively thin, the optical properties of the simulated modulator device will be affected by the layer. FIG. 8B illustrates the transmission as a function of wavelength and gap size, and FIG. 8C illustrates the reflectance as a function of wavelength and gap size. It can be seen that the inclusion of the glass layers does not have a significant effect on the optical properties of the simulated modulator device 110 when compared with those of the simulated modulator device 100 of FIG. 7A.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

I claim:

1. An apparatus, comprising:
a transmissive display having a first side configured for presenting images and a second side configured for receiving light; and
a backlight assembly, comprising:
a light source configured for providing artificial light to the second side of the transmissive display; and
a surface configured for providing ambient light to the second side of the transmissive display.

2. The apparatus of claim 1, wherein the light source is configured to provide artificial light to the second side of the transmissive display when the backlight assembly is in a first position and wherein the surface is configured to reflect ambient light to the second side of the transmissive display when the backlight assembly is in a second position.

3. The apparatus of claim 1, wherein the transmissive display comprises a liquid crystal display (“LCD”).

4. The apparatus of claim 1, wherein the surface is configured to transmit the ambient light to the second side of the transmissive display when the backlight is in closed position at which the backlight assembly is proximate, and substantially parallel to, the transmissive display.

5. The apparatus of claim 1, further comprising a light detector configured to detect ambient light intensity.

6. A mobile communication device that includes the apparatus of claim 1.

7. The apparatus of claim 2, wherein the first position is a closed position at which the backlight assembly is proximate, and substantially parallel to, the transmissive display.

8. The apparatus of claim 2, wherein the surface is configured to transmit the artificial light from the light source when the backlight assembly is in the first position.

9. The apparatus of claim 2, wherein the backlight assembly is configured to turn off the light source when the backlight assembly is in the second position.

10. The apparatus of claim 4, wherein the surface comprises a plurality of micro-mechanical mirrors.

11. The apparatus of claim 5, further comprising a logic system configured to determine whether there is a sufficient ambient light intensity for the transmissive display.

12. The mobile communication device of claim 6, wherein the mobile communication device comprises a cellular telephone or a personal digital assistant.

13. The apparatus of claim 10, wherein the micro-mechanical mirrors are configured to reflect the artificial light when the light source is powered on and configured to allow the ambient light to be transmitted through the surface when the light source is not powered on.

14. The apparatus of claim 11, further comprising prompting means for prompting a user, wherein the logic system is further configured to control the prompting means to prompt a user when there is a sufficient ambient light intensity for the transmissive display.

15. The apparatus of claim 14, wherein the prompting means comprises at least one of a speaker or a display.

16. An apparatus, comprising:
a transmissive display having a first side configured for presenting images and a second side configured for receiving light;
an interface system comprising a user interface and a network interface;
a logic system configured to control the transmissive display and the interface system; and
a backlight assembly, comprising:
a light source configured to provide artificial light to the second side of the transmissive display when the backlight is in a first position; and
a surface configured to reflect ambient light to the second side of the transmissive display when the backlight is in a second position.

17. The apparatus of claim 16, wherein the transmissive display comprises a liquid crystal display (“LCD”).

18. The apparatus of claim 16, wherein the first position is a closed position at which the reflective surface of the backlight assembly is proximate the transmissive display.

19. The apparatus of claim 16, wherein the surface is configured to transmit the artificial light from the light source when the backlight assembly is in the first position.

20. The apparatus of claim 16, wherein the surface comprises a reflective film.

21. The apparatus of claim 16, wherein the surface comprises a plurality of micro-mechanical mirrors.

22. The apparatus of claim 16, wherein the user interface comprises at least one of a key pad or a touch screen.

23. The apparatus of claim 16, wherein the network interface comprises a wireless interface.

24. A mobile communication device that includes the apparatus of claim 16.

25. The apparatus of claim 16, further comprising a light detector configured to detect ambient light intensity.

26. The mobile communication device of claim 24, wherein the mobile communication device comprises a cellular telephone or a personal digital assistant.

27. The apparatus of claim 25, further comprising prompting means for prompting a user, wherein the logic system is further configured to control the prompting means to prompt a user when there is a sufficient ambient light intensity for the transmissive display.

28. The apparatus of claim 27, wherein the prompting means comprises at least one of a speaker or a display.

29. An apparatus, comprising:
transmissive display means for presenting images;
interface means for receiving user input and for communicating with a network;
control means for controlling the transmissive display means and the interface means; and
illumination means for proving illumination to the transmissive display means, the illumination means comprising:
light source means for providing artificial light to the transmissive display means when the illumination means is in a first position; and
means for reflecting ambient light to the transmissive display means when the illumination means is in a second position.

30. A mobile communication device that includes the apparatus of claim 29.
